(19) United States
(12) Patent Application Publication
(10) Pub. No.: US 2023/0216840 A1
(43) Pub. Date: Jul. 6, 2023

(54) DISTRIBUTED WORKSPACE SUPPORT OF SINGLE SIGN-ON FOR WEB APPLICATIONS

(71) Applicant: Citrix Systems, Inc., Ft. Lauderdale, FL (US)

(72) Inventors: Santosh Sampath, Bengaluru (IN); Deepak Sharma, Bengaluru (IN)

(73) Assignee: Citrix Systems, Inc., Ft. Lauderdale, FL (US)

(21) Appl. No.: 17/646,910

(22) Filed: Jan. 4, 2022

(51) Int. Cl. H04L 9/40

(52) U.S. Cl. CPC H04L 63/0815

(57) ABSTRACT

Systems and methods for providing a single sign-on for authenticating a workspace user accessing an application outside of the workspace are provided. For example, the method can include launching a workspace session based upon initial authentication information for the user. The method can further include receiving a request to access an additional application during the workspace session. For example, the request can include launching the additional application in a context such as a system browser. The method can further include blocking authentication of the additional application in the original context, performing an alternative authentication process in an alternate context using the initial authentication information, and providing access to the additional application in the original context based upon the alternative authentication process. As such, a single sign-on authentication can be provided for the user of the distributed workspace session when accessing an additional application launched, for example, in a system browser.

### BACKGROUND

Access to remote resources such as remotely accessible applications generally requires a specific level of security to prevent malicious users from accessing the resources. In many examples, a user performs an authentication when initializing a distributed workspace session. As the user access resources provided within the distributed workspace, the initial authentication information is used to authenticate the user and provide access to the additional resources. However, to access an application that is not provided within the distributed workspace, the user may be required to launch the application in a separate system or secure browser. In such an example, as the application is launched outside of the distributed workspace, the user is prompted to provide additional login and/or authentication information to access the application.

### SUMMARY

In at least one example, a method for providing a single sign-on for authenticating a distributed workspace user accessing an application outside of the distributed workspace is provided. The method includes receiving, by a processing device, authentication information based upon authentication of security credentials of a user of a distributed workspace; launching, by the processing device, a distributed workspace session based upon the authentication information; receiving, by the processing device, a input requesting access to an additional application; blocking, by the processing device, an authentication process associated with the additional application; executing, by the processing device, an alternative authentication process for the additional application using the authentication information for the user; and providing, by the processing device, access to the additional application based upon successful completion of the alternative authentication process.

Implementations of the method for providing a single sign-on for authenticating a distributed workspace user accessing an application outside of the distributed workspace can include one or more of the following features.

In examples of the method, the input requesting access to the additional application can include a request to launch the application in a system browser distinct from the distributed workspace session. In some examples, blocking an authentication process associated with the additional application can include monitoring, by the processing device, communication information exchanged between the system browser and a remote computing device; determining, by the processing device, whether the communication information comprises information related to launching the additional application; and blocking, by the processing device, the authentication process associated with the additional application if the communication information comprises information related to the launching the additional application.

In examples of the method, the input requesting access to the additional application can include a request to launch the application in a secure browser distinct from the distributed workspace session and operated in accordance with a secure browsing service. In some examples, blocking an authentication process associated with the additional application can include monitoring, by the processing device, communication information exchanged between the secure browser and a remote computing device; determining, by the processing device, if the communication information comprises information related to launching the additional application; and blocking, by the processing device, the authentication process associated with the additional application if the communication information comprises information related to the launching the additional application.

In some examples of the method, launching the distributed workspace session based upon the authentication information can include launching, by the processing device, the distributed workspace session as a WebView application.

In some examples of the method, the method can further include performing, by the processing device, the authentication process associated with the additional application based upon an unsuccessful completion of the alternative authentication process.

In another example, a computing device configured to provide a single sign-on for authenticating a distributed workspace user accessing an application outside of the distributed workspace is provided. The computing device can include a computer readable memory and at least one processor operably coupled to the memory. The at least one processor can be configured to receive authentication information based upon authentication of security credentials of a user of a distributed workspace, launch a distributed workspace session based upon the authentication information, receive a input requesting access to an additional application, block an authentication process associated with the additional application, execute an alternative authentication process for the additional application using the authentication information for the user, and provide access to the additional application based upon successful completion of the alternative authentication process.

Implementations of the computing device configured to provide a single sign-on for authenticating a distributed workspace user accessing an application outside of the distributed workspace can include one or more of the following features.

In examples of the computing device, the input requesting access to the additional application can include a request to launch the application in a system browser distinct from the distributed workspace session. In some examples, the at least one processor being configured to block an authentication process associated with the additional application can include the at least one processor being configured to monitor communication information exchanged between the system browser and a remote computing device, determining whether the communication information comprises information related to launching the additional application, and block the authentication process associated with the additional application if the communication information comprises information related to the launching the additional application.

In examples of the computing device, the input requesting access to the additional application can include a request to launch the application in a secure browser distinct from the distributed workspace session and operated in accordance with a secure browsing service. In some examples, the at least one processor being configured to block an authentication process associated with the additional application can include the at least one processor being configured to monitor communication information exchanged between the secure browser and a remote computing device, determine if the communication information comprises information related to launching the additional application, and block the authentication process associated with the additional application if the communication information comprises information related to the launching the additional application.

In examples of the computing device, the at least one processor being configured to launch the distributed workspace session based upon the authentication information can include the at least one processor being configured to launch the distributed workspace session as a WebView application.

In examples of the computing device, the at least one processor can be further configured to perform the authentication process associated with the additional application based upon an unsuccessful completion of the alternative authentication process.

In another example, a system to provide a single sign-on for authenticating a distributed workspace user accessing an application outside of the distributed workspace is provided. The system can include a computer readable memory, a network interface operably coupled to a remote computing device, and at least one processor operably coupled to the memory and the network interface. The at least one processor can be configured to receive authentication information based upon authentication of security credentials of a user of a distributed workspace, launch a distributed workspace session based upon the authentication information, receive a input requesting access to an additional application, block an authentication process associated with the additional application, execute an alternative authentication process for the additional application, and provide access to the additional application based upon a successful completion of the alternative authentication process. The at least one processor being configured to execute the alternate authentication process includes the at least one processor being configured to transmit an authentication request including the authentication information for the user to the remote computing device via the network interface, and receive an authentication response from the remote computing device via the network interface, the authentication response comprising an indication of a successful completion of the alternative authentication process or an unsuccessful completion of the authentication process.

Implementations of the system to provide a single sign-on for authenticating a distributed workspace user accessing an application outside of the distributed workspace can include one or more of the following features.

In examples of the system, the input requesting access to the additional application can include a request to launch the application in a system browser distinct from the distributed workspace session. In some examples, the at least one processor being configured to block an authentication process associated with the additional application can include the at least one processor being configured to monitor communication information exchanged between the system browser and a remote computing device, determining whether the communication information comprises information related to launching the additional application, and block the authentication process associated with the additional application if the communication information comprises information related to the launching the additional application.

In examples of the system, the input requesting access to the additional application can include a request to launch the application in a secure browser distinct from the distributed workspace session and operated in accordance with a secure browsing service. In some examples, the at least one processor being configured to block an authentication process associated with the additional application can include the at least one processor being configured to monitor communication information exchanged between the secure browser and a remote computing device, determine if the communication information comprises information related to launching the additional application, and block the authentication process associated with the additional application if the communication information comprises information related to the launching the additional application.

In examples of the system, the at least one processor being configured to launch the distributed workspace session based upon the authentication information can include the at least one processor being configured to launch the distributed workspace session as a WebView application.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIGS. 1A and 1B are block diagrams of a system architecture for accessing a remote computing device by a client device.

FIG. 2A illustrates a sample system architecture including a client device accessing a distributed workspace session as provided by a remote workspace server, in accordance with at least one example of the present disclosure.

FIGS. 2B and 2C illustrate sample system architectures including a client device accessing a distributed workspace session as well as one or more additional applications, in accordance with at least one example of the present disclosure.

FIG. 3A is a sample sequence diagram for implementing an initial authentication process when accessing a distributed workspace, in accordance with at least one example of the present disclosure.

FIG. 3B is a sample sequence diagram for implementing a single sign-on process when accessing an additional application outside of a distributed workspace session, in accordance with at least one example of the present disclosure.

FIG. 4 is a flow diagram illustrating an overview of a process for implementing a single sign-on process when accessing an additional application outside of a distributed workspace session, in accordance with at least one example of the present disclosure.

FIG. 5A is a sample sequence diagram for implementing an initial authentication process when accessing a distributed workspace using a WebView application, in accordance with at least one example of the present disclosure.

FIG. 5B is an alternative sample sequence diagram for implementing a single sign-on process when accessing an additional application outside of a distributed workspace session, in accordance with at least one example of the present disclosure.

FIG. 6 is a flow diagram illustrating an overview of an alternative process for implementing a single sign-on process when accessing an additional application outside of a distributed workspace session, in accordance with at least one example of the present disclosure.

FIG. 7 is a block diagram of an illustrative enterprise mobility management system, in accordance with at least one example of the present disclosure.

FIG. 8 is a block diagram of a computing device that can implement one or more of the computing devices of FIGS. 1A, 1B, 2A, 2B, and/or 2C, in accordance with at least one example of the present disclosure.

### DETAILED DESCRIPTION

As summarized above, various examples described herein are directed to systems, methods, and processes for providing a single sign-on authentication for applications launched in a system browser and/or a secure browser during a distributed workspace session. The processes as described herein are useful during authentication of a user accessing an additional application when the user has previously been authenticated for access to the distributed workspace session. As such, the single sign-on authentication as described herein works to reduce the overall steps required to authenticate a user accessing the additional application if the user has previously been authenticated to access the distributed workspace session. These systems, methods, and processes as described herein overcome drawbacks that arise in other distributed workspace sessions that require a user to provide additional authentication information when accessing an additional application that is distinct from the distributed workspace session.

To improve the user’s experience with authenticating the user when using an additional application, the systems, methods, and processes as described herein may include using previously determined authentication information for the user to authenticate the user when launching the additional application. For example, during initial authentication of the user when accessing the distributed workspace, a workspace application can receive initial authentication information from an identity provider server. The workspace application can use this authentication information to provide for a single sign-on authentication for additional applications launched during the distributed workspace session as described herein. For example, a browser extension can be configured to monitor for communication between a system browser launching an additional application and one or more remote computing devices. Based upon the communication, the browser extension can be configured to block access by the system browser during authentication of an additional application. Rather than performing the standard authentication for the additional application, the browser extension can direct information to the workspace application such that the workspace application can process the authentication. For example, the workspace application can use information associated with the request to launch the additional application as well as the initial authentication information for the user to perform a single sign-on authentication. As such, the user can be authenticated for the additional application without additional user input. Rather, a single sign-on authentication can be used using the initial authentication information for the user to provide access for the user to the additional application.

Thus, and in accordance with at least some examples disclosed herein, single sign-on authentication systems, methods, and processes are provided that include improved authentication of a user of additional applications that are launched in a system browser during a distributed workspace session. These systems, methods, and processes enhance the quality of users experiences by minimizing the time taken to authenticate the user when accessing an additional application as well as required user input for authenticating the user when accessing the additional application.

In some examples, a method for providing a single sign-on for authenticating a distributed workspace user accessing an application outside of the distributed workspace can be provided. The method can include authenticating the user of a distributed workspace resulting in authentication information for the user. A workspace application associated with the distributed workspace session can maintain or otherwise store the authentication information. The method can further include launching a distributed workspace session based upon the authentication information. The method can further include receiving, by the processing device, a request for access to an additional application by the user of the distributed workspace during the distributed workspace session. For example, the request can include launching the additional application in a system browser. The method can further include blocking an authentication process associated with the additional application, performing an alternative authentication process for the additional application using the authentication information for the user, and providing access to the additional application based upon successful completion of the alternative authentication process. As such, a single sign-on authentication can be provided for the user of the distributed workspace session when accessing an additional application launched, for example, in a system browser.

Examples of the methods, systems, and processes discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

### Sample Computing Systems

In some examples, a distributed system is configured to implement workspace and system access to remote users, thereby providing a central repository of applications, files, and other similar resources to a group of trusted users. A digital workspace can be implemented as a software framework designed to deliver and manage a user’s applications, data, and desktops in a consistent and secure manner, regardless of the user’s device or location. Digital workspaces enhance the user experience by streamlining and automating those tasks that a user performs frequently, such as approving expense reports, confirming calendar appointments, submitting helpdesk tickets, and reviewing vacation requests. A digital workspace allows users to access functionality provided by multiple enterprise applications—including “software as a service” (SaaS) applications, web applications, desktop applications, and proprietary applications—through a single interface.

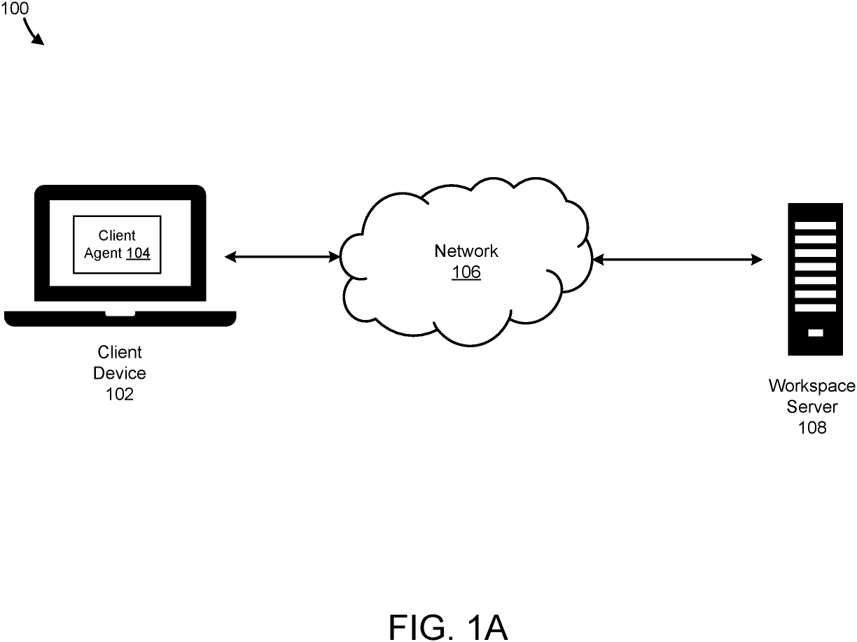

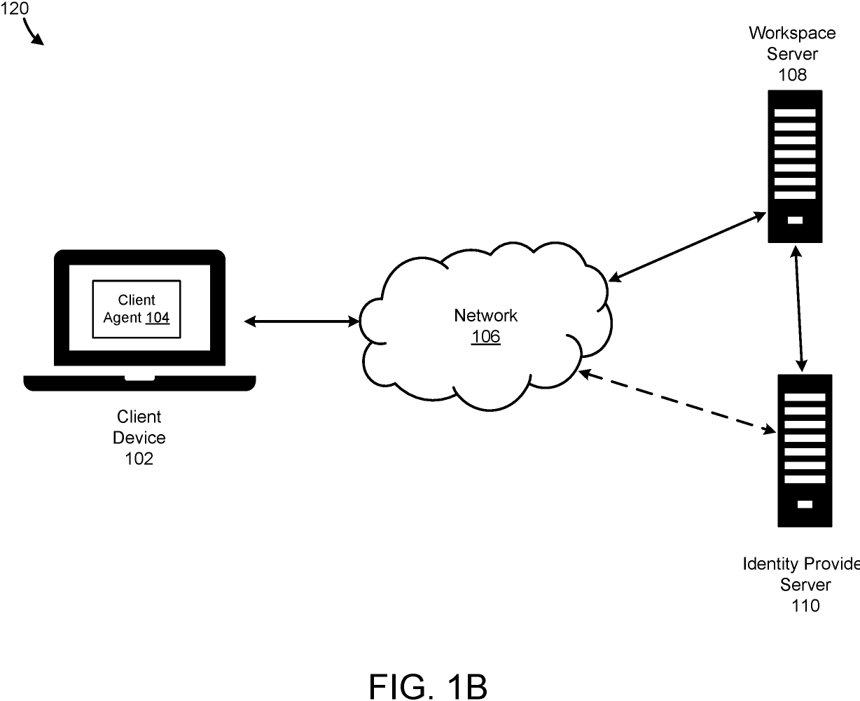

FIG. 1A illustrates a logical architecture of one implementation of, for example, a distributed workspace system 100 that is configured to connect one or more client devices with one or more remote computing devices configured to host shared resources such as applications accessible via the distributed workspace. As shown in FIG. 1A, the system 100 can include a client device 102. As further shown in FIG. 1A, the client device 102 can include a client agent 104. The client agent 104 can be configured to provide an interface to facilitate remote access to one or more resources hosted at or by, for example, a remote computing device such as workspace server 108. In certain implementations, the client device 102 can be operably connected to the workspace server 108 via one or more networks 106. In some examples, the network 106 can be a wired network, a wireless network, or a combination of both wired and wireless networks.

In some examples, the workspace server 108 can execute, operate, or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft Internet Protocol telephone; an application for streaming video and/or audio; an application for facilitating real-time-data communications; a HyperText Transfer Protocol client; a File Transfer Protocol client; an Oscar client; a Telnet client; or any other set of executable instructions.

In some examples, the workspace server 108 can execute a remote presentation services program or other program that uses a thin client or a remote-display protocol to capture display output generated by an application executing on the remote computing device and transmit the application display output to the client device 102 for presentation to one or more device users.

In some examples, the workspace server 108 can include a server agent that is configured to communicate with the client agent 104. The server agent can be configured to, for example, authenticate a client device, provide secure access to one or more remote and/or shared resources, monitor user interactions with the resources, update user access based upon changes to user permission levels for a client device, distribute or properly direct requests to available resources, and perform other similar distributed workspace functions.

In yet other examples, the workspace server 108 can be configured to execute a virtual machine providing, to a user of the client device 102, access to a computing environment. In such an example, the client device 102 can be a virtual machine. The virtual machine can be managed by, for example, a hypervisor, a virtual machine manager (VMM), or any other hardware virtualization technique within the workspace server 108.

In some examples, the network 106 can be: a local area network (LAN); a metropolitan area network (MAN); a wide area network (WAN); a primary public network; and a primary private network. Additional examples can include a network 106 of mobile telephone networks that use various protocols to communicate among mobile devices. For short range communications within a wireless local-area network (WLAN), the protocols can include 802.11, Bluetooth, and Near Field Communication (NFC).

It should be noted that the specific device architecture as shown in FIG. 1A is provided by way of example only. For instance, a single client device 102 is provided by way of example only and system 100 can include additional client devices. Similarly, one workspace server 108 is also shown by way of example only. In certain implementations, multiple remote computing devices can be operably connected to the client devices via, for example, one or more network appliances configured to perform, for example, access control and load balancing.

In some examples as described herein, additional applications such as software as SaaS applications can require additional login in and/or user authentication information prior to launching the application. In such an example, an additional device or service such as an identity provider (IDP) server can be used to perform the additional verification. An example of such a system including an IDP server is shown in FIG. 1B.

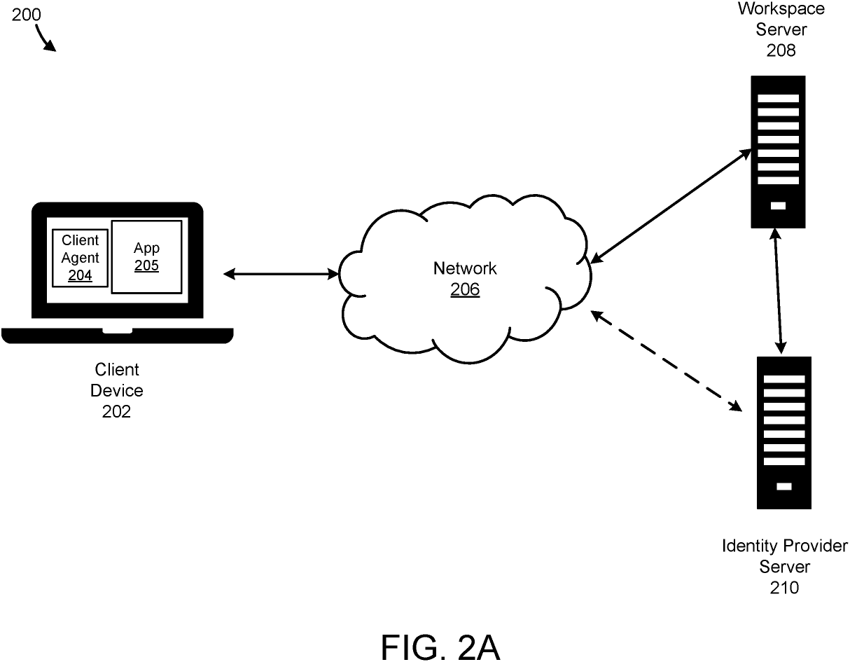

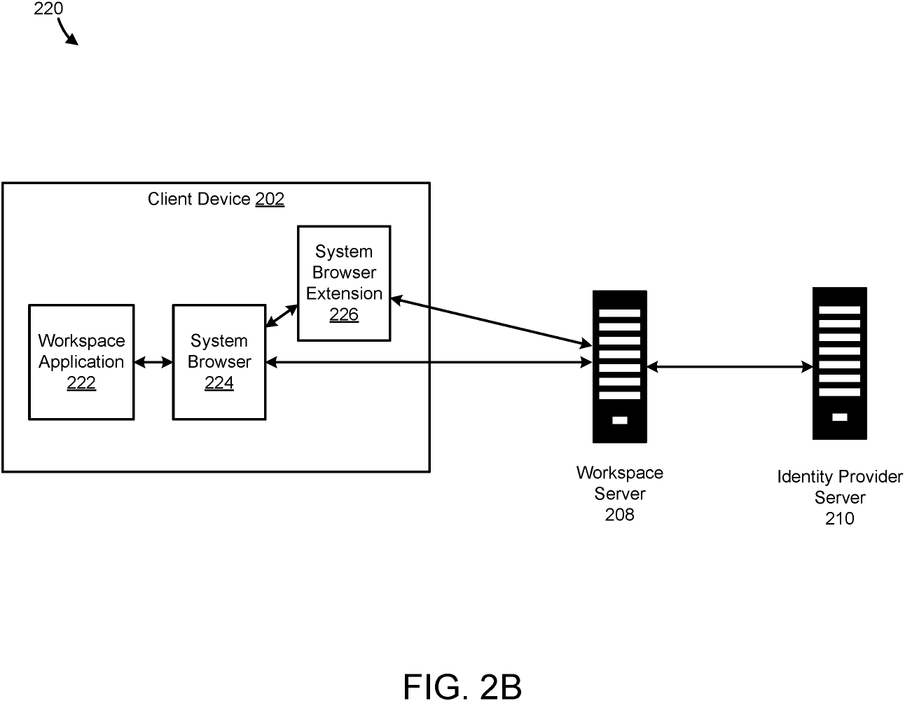

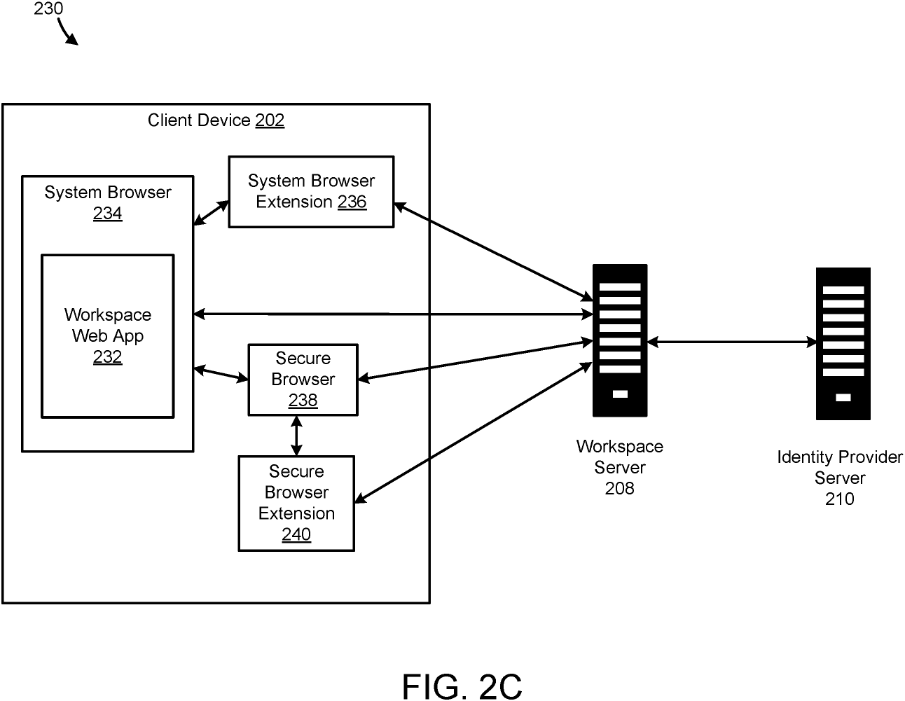

Similar to system 100 as shown in FIG. 1A, system 120 as shown in FIG. 1B includes the client device 102 configured to run the client agent 104 as described above. The client device can be operably coupled to a remote computing device such as the workspace server 108 via a network connection established over the network 106 as described above. However, as further shown in FIG. 2B, the system 120 can further include an IDP server 110. As described herein, the IDP server 110 can provide additional authentication and user verification during a login process for an additional application such as a SaaS application including, for example, a sales application, a task management application, a financial/budget tracking application, a communication and/or teleconferencing application, and other similar applications that may be launched independently of a distributed workspace session as described herein.

In some examples, communication between the client device 102 and the ADP server 110 can be facilitated by the workspace server 108. In other examples, the client device 102 can be configured to communicate directly with the IDP server 110 over, for example, the network 106. As such, it should be noted that the specific device architecture as shown in FIG. 1B is provided by way of example only.

As described herein, when launching an additional application such as a Web/SaaS application, the application can launch in a system browser and/or a secured browser (using, for example, a secured browser service (SBS)) that is separate and distinct from the workspace application that is managing a user’s distributed workspace session. In such an example, additional login and authentication can be required to verify the user in the additional application as the workspace server as described herein has been removed from the authentication chain. More specifically, as the additional application is launched in a browser distinct from the workspace session, an additional login process for the newly launched application is required. The systems and processes as shown in FIGS. 2A-6 and described below can provide for a single sign-on authentication for a user even when accessing applications that launch in a browser distinct from an existing distributed workspace session.

For example, FIG. 2A illustrates system 200 including a client device configured to provide both a distributed workspace session and access to one or more additional applications such as Web/SaaS applications. The system 200 can include client device 202 that is configured to run both a client agent 204 as well as additional applications 205 as described herein. For example, the client agent 204 can be configured to initiate and maintain a distributed workspace session for a user of the client device 202. Additionally, the client device 202 can be configured to run one or more additional applications 205 such as Web/SaaS applications.

As further shown in FIG. 2A, the client device 202 can be operatively connected to one or more remote devices such as workspace server 208 via a network 206. Additionally, the system 200 can include an IDP server 210 configured to provide additional authentication information for an additional application 205 as described herein. For example, if the user of client device 202 launches an additional application 205, the client device may interact with IDP server 210 to authenticate the user and provide full access to the application.

In order to provide for a single sign-on authentication as described herein, one or more resources as included on client device 202 can be modified to process authentication information for an additional application in a modified manner. For example, a system browser configured to launch an additional application as described herein can include a system browser extension that is configured to monitor the operation of the system browser. Based upon specific operations performed by the system browser, the system browser extension can intercept and/or modify communications between the system browser and a remote device such as the workspace server as described herein.

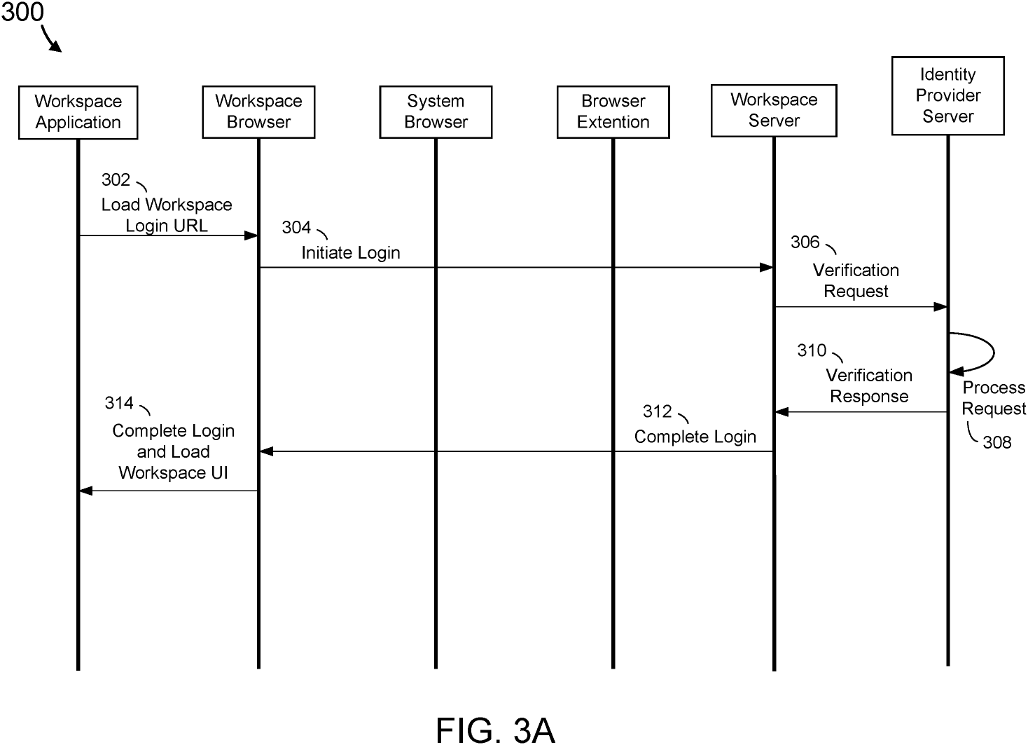

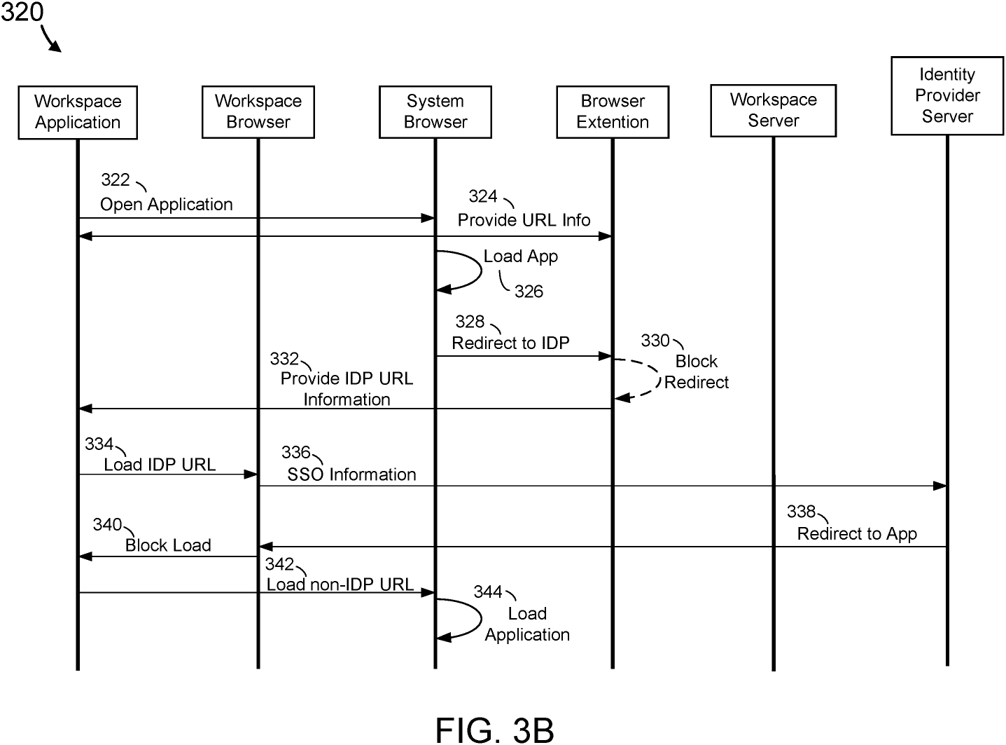

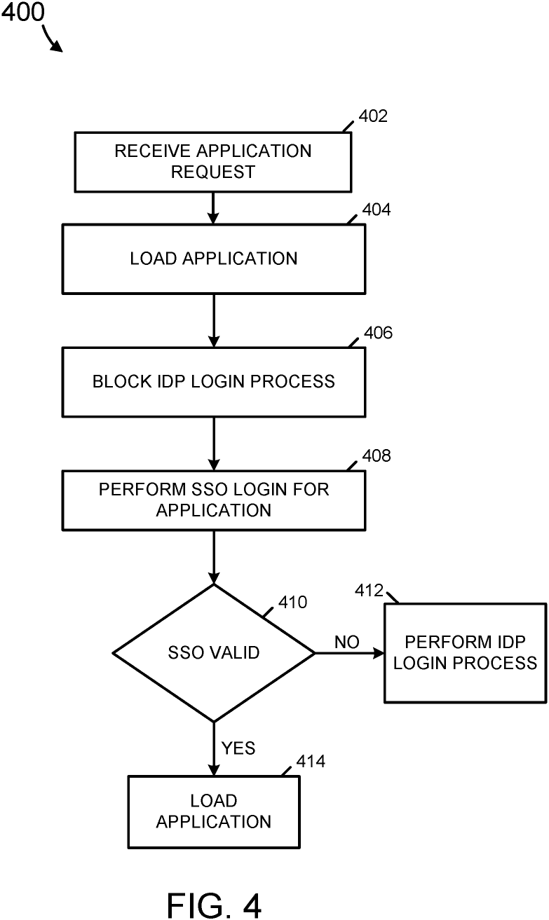

For example, FIG. 2B illustrates a system 220 that includes a client device having a system browser extension configured to modify an authentication process as performed by a system browser. As shown in FIG. 2B, a client device such as client device 202 can include a workspace application 222, a system browser 224, and a system browser extension 226. When launching an additional application, the workspace application 222 can communicate with the system browser 224 to launch the application. Depending upon the type of application launched, the system browser extension 226 can monitor and intercept login information as output by the system browser 224. In certain implementations, the system browser extension 226 can be configured to communicate directly with a workspace server such as workspace server 208 to facilitate a single sign-on authentication as described herein in additional detail below in the discussion of, for example, FIGS. 3B and 4.

In certain implementations, a user may launch a distributed workspace session within a system browser using, for example, a WebView version of the distributed workspace application. In such an example, when launching an additional application such as a Web/SaaS application, the WebView application, running within the system browser, may launch the additional application in an additional browser such as a secure browser. In some examples, the WebView version of the distributed workspace can launch a virtual instance of a secure browser window using, for example, an SBS configured to remotely run the secure browser instance and provide an interface to the secure browser via, for example, the system browser. By using such an arrangement, the secure browser is hosted on a device that is isolated form the client device to provide added security. However, as the single sign-on techniques as described herein provide for user authentication for a Web/SaaS application in the same context as the original user authentication for the distributed workspace session, a single sign-on can be performed for an additional application being opened in a secure browser as described herein.

In such an example, the secure browser can include an associated secure browser extension that is configured to operate similar to the system browser extension as described above. More specifically, the secure browser extension can be configured to monitor information output by the secure browser and intercept authentication and/or login information to provide for a single sign-on authentication as described herein.

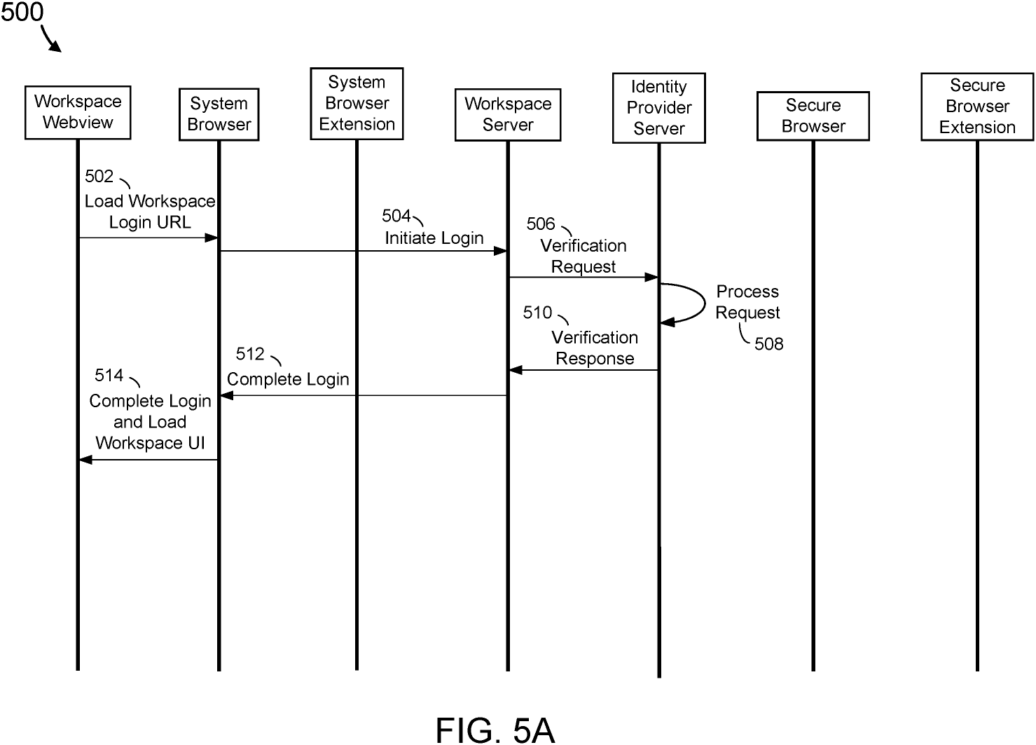

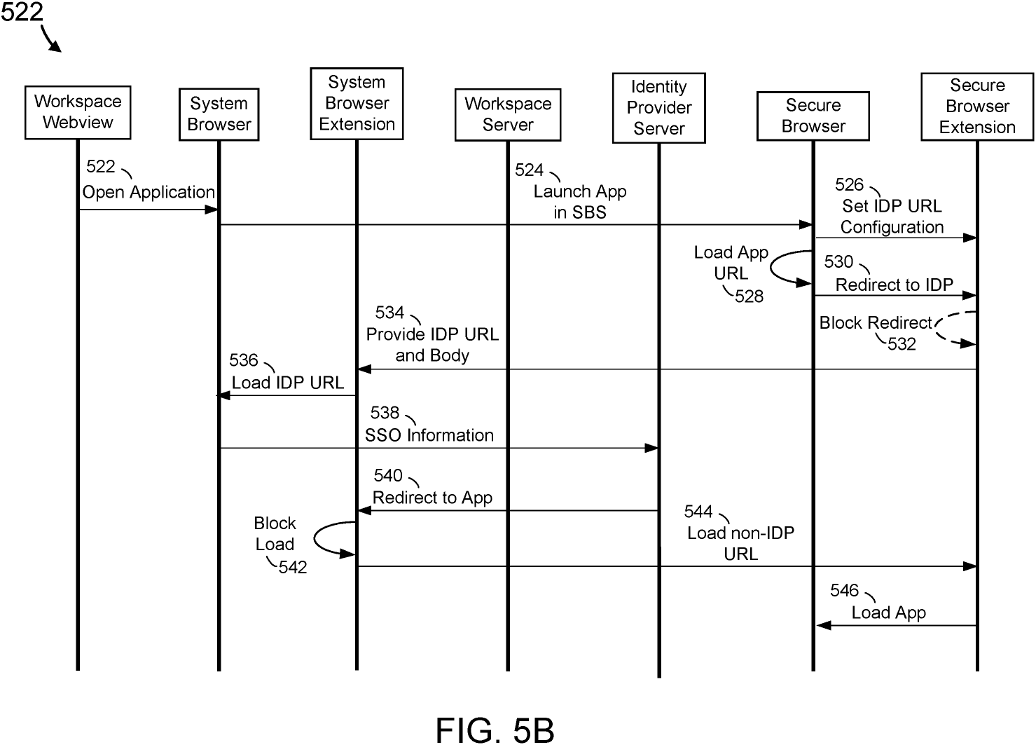

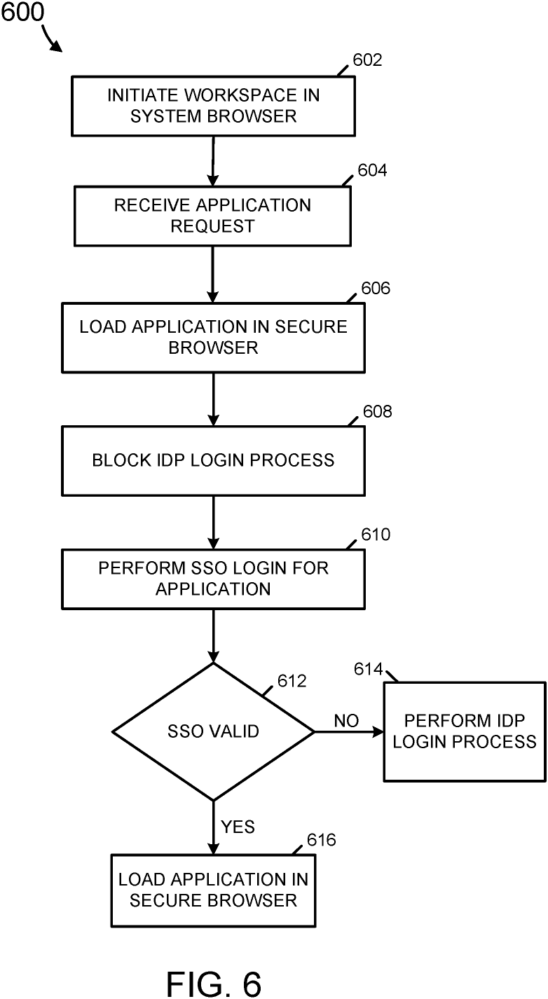

For example, FIG. 2C illustrates a system 230 that includes a client device having a secure browser extension configured to modify and authentication process as performed by a WebView version of a workspace application running within a system browser. As shown in FIG. 2C, a client device 202 can include a WebView workspace application 232 configured to operate within a system browser 234. Similar to the system 220 as shown in FIG. 2B, the client device 202 can further include a system browser extension 236 configured to monitor output of the system browser 234. Additionally, the client device 202 can include a secure browser 238 (or, if the secure browser is being remotely run, a virtual interface to the secure browser) configured to launch one or more additional applications as described herein. As further shown in FIG. 2C, the client device 202 can include a secure browser extension 240 that is configured to monitor the output of the secure browser 238. In certain implementations, the secure browser extension 240 can be configured to monitor and intercept login information as output by the secure browser 238. In some examples, the secure browser extension 240 can be configured to communicate with a workspace server such as workspace server 208 to facilitate a single sign-on authentication as described herein in additional detail below in the discussion of, for example, FIGS. 5B and 6.

Each of the browser extensions as described above (the system browser extensions and the secure browser extensions) can be implemented as a set of executable computer instructions and/or macros that are configured to perform various functions. For example, the browser extensions can be configured to monitor any universal resource locators (URLs) that a system and/or secure browser is directed to. For each accessed URL, the browser extension can determine if the URL is associated with a Web/SaaS or other similar additional application that can be accessed using a single sign-on authentication as described herein. For example, the browser extensions can be regularly updated (e.g., via an administrative interface exposed and implemented by the workspace server 208) to include a listing of additional applications associated with a client device that can use a single sign-on authentication as described herein. If a monitored URL is associated with an additional application that can use a single sign-on authentication as described herein, the browser extensions can include additional instructions for further processing authentication information as described below.

### Sample Implementation Processes

As noted above, the single sign-on authentication processes for additional applications as described herein can be used in various environments. For example, the processes can be used when launching an application in a system browser that is launched outside of a workspace application running on a client device. Similarly, the processes can be used when accessing a distributed workspace session in a WebView application within a system browser. In such an example, launching an additional application can include launching the application in a secure browser that requires additional authentication information during application login. The examples as shown in FIGS. 3A-4 and described below are directed to the first example where a user initiates a distributed workspace session within a workspace application. The examples as shown in FIGS. 5A-6 and described below are directed to the second example where a user initiates a distributed workspace session within a WebView application running within a system browser.

It should be noted that, as described herein, a system browser refers to a browser that is configured to operate as intended by the manufacturer when providing the browser without an overly limiting set of constraints. For example, system browsers can include web browsers as included with an operating system on a computing device. As used herein, a secure browser refers to a browser that is generally limited in functionality to those functions that are specifically required by a particular application. Such a secure browser may be included when purchasing/leasing an additional application such as a Web/SaaS application for the purposes of accessing features associated with those applications. However, unless specifically defined herein, the described functionality of both the system browser and the secure browser can be interchanged accordingly. Additionally, as referred to herein and described above, a secure browser can be configured to operate in concert with a secure browser service configured to isolate the secure browser from potentially malicious network traffic and provide a secure browsing session.

FIG. 3A illustrates a sample sequence 300 for a user performing an initial login when accessing a distributed workspace session using a workspace application. As shown in FIG. 3A, the sequence 300 has various devices and or components performing one or more functions and/or process steps. For example, the devices and/or components can include a workspace application such as a workspace application 222 as shown in FIG. 2B and described above, a workspace browser including, for example, a browser embedded within the workspace application 222, a system browser such as system browser 224 as shown in FIG. 2B and described above, a browser extension such as browser extension 226 as shown in FIG. 2B and described above, a workspace server such as workspace server 208 as shown in FIG. 2B and described above, and an IDP server such as IDP server 210 as shown in FIG. 2B and described above.

More specifically, as shown in FIG. 3A, the workspace application can load 302 a workspace login URL within the workspace browser. In response, the workspace browser can initiate 304 a login process with the workspace server. The workspace server can receive the login request and transmit 306 a verification request to the IDP server for authentication of the user accessing the workspace application. The IDP server can process 308 the verification request to determine whether the user is permitted to access the distributed workspace. Based upon the processing, the IDP server can issue 310 a verification response to the workspace server. The workspace server can process the verification response and transmit 312 completed login information to the workspace browser. The workspace browser can receive the completed login information, process the login information, and complete 314 the login process and load the workspace user interface (UI) within the workspace application such that the user can access a distributed workspace session.

FIG. 3B illustrates a sample sequence 320 for providing a single sign-on authentication to the user of a distributed workspace session. The single sign-on session can provide for authentication of the user for an additional application launched in, for example, a system browser outside of the distributed workspace session as described herein. In certain implementations, the sequence 320 as shown in FIG. 3B follows the authentication process as shown in sequence 300 of FIG. 3A.

As shown in FIG. 3B, a user can access the workspace application and request access to a Web/SaaS application. For example, the user can select a link in the workspace application and/or the system browser by selecting, for example, a link (e.g., as included in an email, text document, chat message, etc.) or a bookmark. In response to a user request, the workspace application can open 322 an additional application such as a Web/SaaS application as described herein. As shown in FIG. 3B, the workspace application can open 322 the application in, for example, an original application context such as the system browser. Additionally, the workspace application can provide 324 URL information to the browser extension associated with the system browser as described herein. In some examples, the browser extension and the workspace application can exchange additional information such that the browser extension can initiate the single sign-on authentication as described herein. For example, the browser extension can transmit a GET request to the workspace application for additional information related to the additional application. In response to the GET request, the workspace application can provide 324 the URL information to the browser extension. In some examples, the browser extension can transmit a POST request to the workspace application. In response to the POST request, the workspace application can provide 324 the URL information as well as any header and body information associated with opening the additional application. In some examples, the workspace application can be configured to provide 324 the information to the browser extension as an encoded form.

In some examples, the browser extension also monitors URLs accessed directly by the system browser. In such an example, if a URL is accessed that is associated with an additional application that can include single sign-on authentication as described herein. In certain implementations, a user may access or otherwise launch a web-based application in the system browser (or, in some examples, a secure browser as described herein). In such an implementation, the browser extension can monitor the URL being loaded by the system browser and determine that the additional application can use the single sign-on authentication based upon the previous authentication of the user within the workspace application context. Rather than reauthenticating the user by performing the standard IDP authentication, the system browser can block the load of the application and the sequence as shown in FIG. 3B and described below can be used to provide for a single sign-on authentication of the user of the additional application.

In response to the request to open the application, the system browser can load 326 the additional application and begin to direct the user to the IDP authentication page for the additional application. For example, upon loading the application, the system browser can redirect 328 to an IDP server as instructed by the additional application to complete an authentication process associated with the additional application. The browser extension can monitor the communications between the system browser and a remote computing device such as the workspace server or the IDP server for particular information such as a redirect to the IDP server for authentication. In certain implementations, the system browser extension can be configured to monitor for communication with specific URLs associated with one or more Web/SaaS applications that can implement the single sign-on process as described herein. For example, the system browser extension can access a data structure including a list of IDP URLs that can be opened or otherwise accessed using a single sign-on authentication based upon distributed workspace authentication information as described herein.

In response to the redirect to the IDP server, the browser extension can block 330 the redirect to the IDP server, thereby automatically pausing the authentication process associated with the additional application in the original context (i.e., within the system browser) and initiating the single sign-on process in an alternate context (i.e., within the workspace application and/or workspace browser) as described herein. In certain implementations, the browser extension can be configured to update the user output of the system browser to provide information to the user. For example, the browser extension can load a generic hypertext markup language (HTML) page within the system browser that reads “Please Wait for User Authentication.”

The browser extension can further provide 332 the IDP URL information to the workspace application for further processing to perform the user authentication in the alternate context. In certain implementations, the browser extension can provide additional information such as the URL and header and/or body information associated with the IDP URL transmission. The workspace application can load 334 the IDP URL information within the workspace browser and process the IDP authentication information in the alternate context. The workspace browser can transmit 336 single sign-on information to the IDP server for further processing. For example, the single sign-on information can include initial authentication information as determined for the user during an initial authentication process similar to the process as shown in FIG. 3A and described above. Additionally, the single sign-on information can include the IDP URL information such as the URL and header and/or body information from the IDP URL information for processing by the IDP server. The IDP server can process the single sign-on information. The workspace application can monitor information exchanged with the IDP server and determine whether the IDP server has transmitted a URL configured to redirect 338 the workspace application based upon the single sign-on information. For example, the single sign-on information can include verification information that is based upon the initial authentication information, the verification information formatted or otherwise configured to provide user access to the additional application. In some implementations, the verification information can include a token or other similar secure data structure that can represent approval of the initial authentication information for the user to access the additional application.

In response to the redirect, the workspace application can monitor the workspace browser to determine if there is navigation to a non-IDP URL based upon the response from the IDP server. In such an example, the workspace browser can block 340 the load of the IDP URL by the workspace application, thereby blocking the load of the additional application within the alternate context (i.e., blocking the load of the additional application within the workspace application). The workspace application can further load 342 and provide the non-IDP URL to the system browser, the non-IDP URL based upon the results of the single sign-on authentication for the additional application. If the single sign-on authentication for the additional application is successful, the system browser can load 344 the additional application for access by the user of the distributed workspace session within the original context as requested by the user (i.e., directly within the system browser). Conversely, if the single sign-on authentication for the additional application is unsuccessful, the system browser can continue with the initial authentication associated with the additional application and prompt the user of the additional application for their login information for verification directly with the IDP server.

The process as outlined by sequence 320 can be configured to be transparent or essentially transparent to the user of the distributed workspace session. By automatically blocking the redirect to the IDP server, the browser extension effectively performs the single sign-on process without any additional input from the user, thereby providing the user with an efficient single sign-on authentication for one or more Web/SaaS applications. However, as noted above, information as displayed to the user by the system browser can be updated to provide the user with information related to the single sign-on authentication.

FIG. 4 illustrates a sample process 400 for providing a single sign-on authentication for an application launched outside of a distributed workspace session as described herein. The process 400 as shown in FIG. 4 can be implemented by a processor of, for example, a client device such as client device 102 or 202 as shown in FIGS. 1 and 2 and described above. As shown in FIG. 4, by way of example, process 400 begins after the user has been authenticated and provided access to the distributed workspace session. As such, the process 400 aligns with at least a portion of sequence 320 as shown in FIG. 3B.

As shown in FIG. 4, the process 400 can begin when the processor receives 402 a request to open an additional application from a user of the distributed workspace session in an original context as associated with the additional application. As described herein, the additional application can be a Web/SaaS application that is launched outside of the distributed workspace session. The processor can load 404 the application within, for example, a system browser as described herein (i.e., the original context). The processor can further implement a browser extension to block 406 the IDP login process associated with the additional application. In response to blocking the IDP login process, the processor can further perform 408 a single sign-on authentication in an alternate context (i.e., within an workspace application) for the additional application in line with the single sign-on authentication process as shown in FIG. 3B and described above.

As further shown in FIG. 4, the processor can be configured to determine 410 if the single sign-on authentication for the additional application is valid. If the processor determines 410 that the single sign-on authentication for the additional application is not valid, the processor can continue to perform 412 the IDP login process as associated with the additional application and within the original context (i.e., within the system browser). Conversely, if the processor does determine 410 that the single sign-on authentication is valid, the processor can provide application information to the system browser and load 414 the application in the original context using the single sign-on authentication for the user of the distributed workspace session as performed in the alternate context (i.e., within the workspace application as described herein).

FIG. 5A illustrates a sample sequence 500 for a user performing an initial login when accessing a distributed workspace session using a WebView application launched, for example, in conjunction with a system browser. As shown in FIG. 5A, the sequence 500 has various devices and or components performing one or more functions and/or process steps. For example, the devices and/or components can include a workspace WebView application such as a workspace WebView application 232 as shown in FIG. 2C and described above, a system browser configured to run the workspace WebView application such as system browser 234 as shown in FIG. 2C and described above, a system browser extension such as system browser extension 236 as shown in FIG. 2C and described above, a workspace server such as workspace server as shown in FIG. 2C and described above, an IDP server such as IDP server 210 as shown in FIG. 2C and described above, a secure browser such as secure browser 238 as shown in FIG. 2C and described above, and a secure browser extension such as secure browser extension 240 as shown in FIG. 2C and described above.

More specifically, as shown in FIG. 5A, the workspace WebView application can load 502 a workspace login URL in conjunction with the system browser. In response, the system browser can initiate 504 a login process with the workspace server. The workspace server can receive the login request and transmit 506 a verification request to the IDP server for authentication of the user accessing the workspace application. The IDP server can process 508 the verification request to determine whether the user is permitted to access the distributed workspace. Based upon the processing, the IDP server can issue 510 a verification response to the workspace server. The workspace server can process the verification response and transmit 512 completed login information to the system browser. The system browser can receive the completed login information, process the login information, and complete 514 the login process and load the workspace user interface (UI) (e.g., a web page served by the workspace server) within the workspace WebView application such that the user can access a distributed workspace session.

FIG. 5B illustrates a sample sequence 520 for providing a single sign-on authentication to the user of a distributed workspace session. The single sign-on session can provide for authentication of the user for an additional application launched in, for example, a secure browser in concert with an SBS outside of the distributed workspace session as described herein. In certain implementations, the sequence 520 as shown in FIG. 5B follows the authentication process as shown in sequence 500 of FIG. 5A.

As shown in FIG. 5B, a user can access the workspace WebView application and request access to an additional application such as a Web/SaaS application. For example, the user can select a link in the WebView application by selecting, for example, a link or a bookmark. In response to a user request, the workspace WebView application can initiate 522 the additional application such as a Web/SaaS application as described herein. As shown in FIG. 5B, in response to the request to open the application, the system browser can launch 524 the application using the secure browser and SBS, thereby launching the application in an original context (i.e., within the secure browser). The secure browser can send 526 the IDP URL information to the browser extension associated with the secure browser as described herein for authenticating the user of the additional application. Additionally, in response to the request to open the application, the secure browser can load 528 the additional application and begin to direct the user to the IDP authentication page for the additional application. For example, upon loading the application, the secure browser can redirect 530 to an IDP server as instructed by the additional application to complete an authentication process associated with the additional application. The secure browser extension can monitor the communications between the system browser and a remote computing device such as the workspace server or the IDP server for particular information such as a redirect to the IDP server for authentication. In certain implementations, the secure browser extension can be configured to monitor for communication with specific URLs associated with one or more Web/SaaS applications that can implement the single sign-on process as described herein. For example, the system browser extension can access a data structure including a list of IDP URLs that can be opened or otherwise accessed using a single sign-on authentication based upon distributed workspace authentication information as described herein.

In response to the redirect to the IDP server, the secure browser extension can block 532 the redirect, thereby automatically pausing the authentication process associated with the additional application within the original context and initiating the single sign-on process as described herein in an alternate context (i.e., within the WebView workspace application). In certain implementations, the secure browser extension can be configured to update the user output of the system browser to provide information to the user. For example, the secure browser extension can load a generic HTML page within the secure browser that reads “Please Wait for User Authentication.”

To transition the single sign-on process to the alternate context associated with the initial user verification (i.e., the client device running the WebView workspace application and the system browser), the secure browser extension can further provide 534 the IDP URL information to the system browser for further processing. In certain implementations, the browser system extension can intercept the IDP URL information and provide additional information such as the URL and header and/or body information associated with the IDP URL transmission to the system browser for processing the IDP authentication in the alternate context. In response, the system browser can load 536 the IDP URL information. The system browser can further transmit 538 single sign-on information to the IDP server for further processing. For example, the single sign-on information can include initial authentication information as determined for the user during an initial authentication process similar to the process as shown in FIG. 5A and described above. Additionally, the single sign-on information can include the IDP URL information such as the URL and header and/or body information from the IDP URL information for processing by the IDP server. In some examples, the secure browser extension and the system browser extension can exchange additional information such that the system browser extension can initiate the single sign-on authentication as described herein. For example, the system browser extension can transmit a GET request to the secure browser extension for additional information related to the additional application. In response to the GET request, the secure browser extension can provide 534 the URL information to the system browser extension. In some examples, the system browser extension can transmit a POST request to the secure browser extension. In response to the POST request, the secure browser extension can provide 534 the URL information as well as any header and body information associated with opening the additional application. In some examples, the secure browser extension can be configured to provide 534 the information to the system browser extension as an encoded form.

The IDP server can process the single sign-on information and transmit a URL configured to redirect 540 the system browser based upon the single sign-on information. The system browser extension can intercept the redirect from the IDP server and process the redirect information from the IDP server. In response to the redirect, the system browser extension can monitor the system browser to determine if there is navigation to a non-IDP URL based upon the response from the IDP server. In such an example, the system browser extension can block 542 the load of the IDP URL by the workspace application, thereby blocking the load of the additional application within the alternate context (i.e., by blocking the load of the additional application within the WebView workspace application). The system browser extension can further load 544 and provide the non-IDP URL to the secure browser, the non-IDP URL based upon the results of the single sign-on authentication for the additional application. If the single sign-on authentication for the additional application is successful, the secure browser can load 546 the additional application within the original context (i.e., within the secure browser) for access by the user of the distributed workspace session. Conversely, if the single sign-on authentication for the additional application is unsuccessful, the secure browser can continue with the initial authentication associated with the additional application and prompt the user of the additional application for their login information for verification directly with the IDP server.

The process as outlined by sequence 520 can be configured to be transparent or essentially transparent to the user of the distributed workspace session. By automatically blocking the redirect to the IDP server, the secure browser extension effectively performs the single sign-on process without any additional input from the user, thereby providing the user with an efficient single sign-on authentication for one or more Web/SaaS applications. However, as noted above, information as displayed to the user by the system browser and/or secure browser can be updated to provide the user with information related to the single sign-on authentication.

FIG. 6 illustrates a sample process 600 for providing a single sign-on authentication for an application launched outside of a distributed workspace session as described herein. The process 600 as shown in FIG. 6 can be implemented by a processor of, for example, a client device such as client device 102 or 202 as shown in FIGS. 1 and 2 and described above.

As shown in FIG. 6, the process 600 can begin when the processor initiates 602 a workspace WebView application within a system browser. For example, the processor can perform a user authentication similar to the process as shown in sequence 500 of FIG. 5A and described above. After the workspace WebView application is initiated, the processor can receive 604 a request to open an additional application from a user of the distributed workspace session. As described herein, the additional application can be a Web/SaaS application that is launched outside of the distributed workspace session using, for example, a secure browser in concert with an SBS (e.g., launching the application in an original context as described herein). The processor can load 606 the application within, for example, a secure browser. The processor can further implement a secure browser extension to block 608 the IDP login process associated with the additional application. In response to blocking the IDP login process, the processor can further perform 610 a single sign-on authentication in an alternate context for the additional application in line with the single sign-on authentication process as shown in FIG. 5B and described above.

As further shown in FIG. 6, the processor can be configured to determine 612 if the single sign-on authentication for the additional application is valid. If the processor determines 612 that the single sign-on authentication for the additional application is not valid, the processor can continue to perform 614 the IDP login process as associated with the additional application. Conversely, if the processor does determine 612 that the single sign-on authentication is valid, the processor can provide application information to the secure browser and load 616 the application in the original context using the single sign-on authentication for the user of the distributed workspace session as determined and verified in the alternate context (i.e., within the WebView workspace application).

### Hardware Implementation Examples

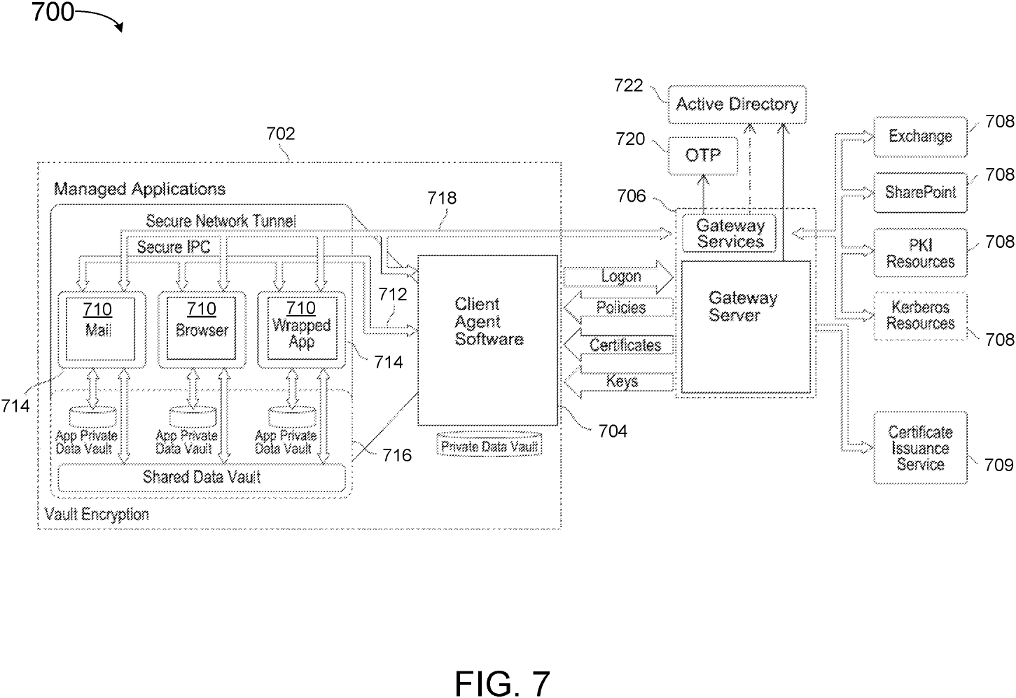

FIG. 7 depicts an illustrative enterprise management system 700 that can include, for example, one or more of an enterprise host service (e.g., workspace server 208) and a mobile device management (MDM) server as a combined gateway server 706 as described below. As shown in FIG. 7, the left hand side represents an enrolled mobile device 702 with a client agent 704, which interacts with gateway server 706 (which includes Access Gateway and application controller functionality) to access various enterprise resources 708 and services 709 such as Exchange, Sharepoint, public-key infrastructure (PKI) Resources, Kerberos Resources, Certificate Issuance service, as shown on the right hand side above. Although not specifically shown, the mobile device 702 may also interact with an enterprise application store (StoreFront) for the selection and downloading of applications.

The client agent 704 acts as the UI (user interface) intermediary for Windows apps/desktops hosted in an Enterprise data center, which are accessed using the High-Definition User Experience (HDX)/ICA display remoting protocol. The client agent 704 also supports the installation and management of native applications on the mobile device 702, such as native iOS or Android applications. For example, the managed applications 710 (mail, browser, wrapped application) shown in the figure above are all native applications that execute locally on the mobile device 702. Client agent 704 and application management framework of this architecture act to provide policy driven management capabilities and features such as connectivity and single sign-on to enterprise resources/services 708. The client agent 704 handles primary user authentication to the enterprise, normally to Access Gateway (AG) 706 with single sign-on to other gateway server components. The client agent 704 obtains policies from gateway server 706 to control the behavior of the managed applications 710 on the mobile device 702.

The Secure InterProcess Communication (IPC) links 712 between the native applications 710 and client agent 704 represent a management channel, which may allow a client agent to supply policies to be enforced by the application management framework 714 “wrapping” each application. The IPC channel 712 may also allow client agent 704 to supply credential and authentication information that enables connectivity and single sign-on to enterprise resources 708. Finally, the IPC channel 712 may allow the application management framework 714 to invoke user interface functions implemented by client agent 704, such as online and offline authentication.

Communications between the client agent 704 and gateway server 706 are essentially an extension of the management channel from the application management framework 714 wrapping each native managed application 710. The application management framework 714 may request policy information from client agent 704, which in turn may request it from gateway server 706. The application management framework 714 may request authentication, and client agent 704 may log into the gateway services part of gateway server 706 (for example, Citrix Gateway). Client agent 704 may also call supporting services on gateway server 706, which may produce input material to derive encryption keys for the local data vaults 716, or may provide client certificates which may enable direct authentication to PKI protected resources, as more fully explained below.

In more detail, the application management framework 714 “wraps” each managed application 710. This may be incorporated via an explicit build step, or via a post-build processing step. The application management framework 714 may “pair” with client agent 704 on first launch of an application 710 to initialize the Secure IPC channel 712 and obtain the policy for that application. The application management framework 714 may enforce relevant portions of the policy that apply locally, such as the client agent login dependencies and some of the containment policies that restrict how local operating system services may be used, or how they may interact with the managed application 710.

The application management framework 714 may use services provided by client agent 704 over the Secure IPC channel 712 to facilitate authentication and internal network access. Key management for the private and shared data vaults 716 (containers) may be also managed by appropriate interactions between the managed applications 710 and client agent 704. Vaults 716 may be available only after online authentication or may be made available after offline authentication if allowed by policy. First use of vaults 716 may require online authentication, and offline access may be limited to at most the policy refresh period before online authentication is again required.

Network access to internal resources may occur directly from individual managed applications 710 through Access Gateway 706. The application management framework 714 may be responsible for orchestrating the network access on behalf of each managed application 710. Client agent 704 may facilitate these network connections by providing suitable time limited secondary credentials obtained following online authentication. Multiple modes of network connection may be used, such as reverse web proxy connections and end-to-end virtual private network (VPN) style tunnels 718.

The Mail and Browser managed applications 710 have special status and may make use of facilities that might not be generally available to arbitrary wrapped applications. For example, the Mail application 710 may use a special background network access mechanism that allows it to access an Exchange server 708 over an extended period of time without requiring a full AG login. The Browser application 710 may use multiple private data vaults 716 to segregate different kinds of data.

This architecture may support the incorporation of various other security features. For example, gateway server 706 (including its gateway services) in some cases may not need to validate active directory (AD) passwords. It can be left to the discretion of an enterprise whether an AD password may be used as an authentication factor for some users in some situations. Different authentication methods may be used if a user is online or offline (i.e., connected or not connected to a network).

Step up authentication is a feature wherein gateway server 706 may identify managed native applications 710 that are allowed to have access to highly classified data requiring strong authentication, and ensure that access to these applications is only permitted after performing appropriate authentication, even if this means a re-authentication is required by the user after a prior weaker level of login.

A security feature of system 700 can include encryption of the data vaults 716 (containers) on the mobile device 702. The vaults 716 may be encrypted so that all on-device data including files, databases, and configurations are protected. For on-line vaults, the keys may be stored on the server (gateway server 706), and for off-line vaults, a local copy of the keys may be protected by a user password or biometric validation. If or when data is stored locally on the mobile device 702 in the secure container 716, it may be preferred that a minimum of AES 256 encryption be utilized.

Other secure container features may also be implemented. For example, a logging feature may be included, wherein security events happening inside a managed application 710 may be logged and reported to the backend. Data wiping may be supported, such as if or when the managed application 710 detects tampering, associated encryption keys may be written over with random data, leaving no hint on the file system that user data was destroyed. Screenshot protection may be another feature, where an application may prevent any data from being stored in screenshots. For example, the key window’s hidden property may be set to YES. This may cause whatever content is currently displayed on the screen to be hidden, resulting in a blank screenshot where any content would normally reside.

Another security feature may relate to the use of an OTP (one time password) 720 without the use of an AD (active directory) 722 password for access to one or more applications. In some cases, some users do not know (or are not permitted to know) their AD password, so these users may authenticate using an OTP 720 such as by using a hardware OTP system like SecurID (OTPs may be provided by different vendors also, such as Entrust or Gemalto). In some cases, after a user authenticates with a user ID, a text may be sent to the user with an OTP 720. In some cases, this may be implemented only for online use, with a prompt being a single field.

An offline password may be implemented for offline authentication for those managed applications 710 for which offline use is permitted via enterprise policy. For example, an enterprise may want StoreFront to be accessed in this manner. In this case, the client agent 704 may require the user to set a custom offline password and the AD password is not used. Gateway server 706 may provide policies to control and enforce password standards with respect to the minimum length, character class composition, and age of passwords, such as described by the standard Windows Server password complexity requirements, although these requirements may be modified.

Another feature may relate to the enablement of a client side certificate for certain applications 710 as secondary credentials (for the purpose of accessing PKI protected web resources via the application management framework micro VPN feature). For example, a managed application 710 may utilize such a certificate. In this case, certificate-based authentication using ActiveSync protocol may be supported, wherein a certificate from the client agent 704 may be retrieved by gateway server 706 and used in a keychain. Each managed application 710 may have one associated client certificate, identified by a label that is defined in gateway server 706.

Gateway server 706 may interact with an enterprise special purpose web service to support the issuance of client certificates to allow relevant managed applications to authenticate to internal PKI protected resources.

The client agent 704 and the application management framework 714 may be enhanced to support obtaining and using client certificates for authentication to internal PKI protected network resources. More than one certificate may be supported, such as to match various levels of security and/or separation requirements. The certificates may be used by the Mail and Browser managed applications 710, and ultimately by arbitrary wrapped applications 710 (provided those applications use web service style communication patterns where it is reasonable for the application management framework to mediate secure hypertext transfer protocol (HTTPS) requests).

Application management client certificate support on iOS may rely on importing a public-key cryptography standards (PKCS) 12 BLOB (Binary Large Object) into the iOS keychain in each managed application 710 for each period of use. Application management framework client certificate support may use a HTTPS implementation with private in-memory key storage. The client certificate may not be present in the iOS keychain and may not be persisted except potentially in “online-only” data value that is strongly protected.

Mutual secure socket layer (SSL) or transport layer security (TLS) may also be implemented to provide additional security by requiring that a mobile device 702 is authenticated to the enterprise, and vice versa. Virtual smart cards for authentication to gateway server 706 may also be implemented.

Another feature may relate to application container locking and wiping, which may automatically occur upon jail-break or rooting detections, and occur as a pushed command from administration console, and may include a remote wipe functionality even when a managed application 710 is not running.

A multi-site architecture or configuration of enterprise application store and an application controller may be supported that allows users to be serviced from one of several different locations in case of failure.

In some cases, managed applications 710 may be allowed to access a certificate and private key via an API (for example, OpenSSL). Trusted managed applications 710 of an enterprise may be allowed to perform specific Public Key operations with an application’s client certificate and private key. Various use cases may be identified and treated accordingly, such as if or when an application behaves like a browser and no certificate access is required, if or when an application reads a certificate for “who am I,” if or when an application uses the certificate to build a secure session token, and if or when an application uses private keys for digital signing of important data (e.g. transaction log) or for temporary data encryption.

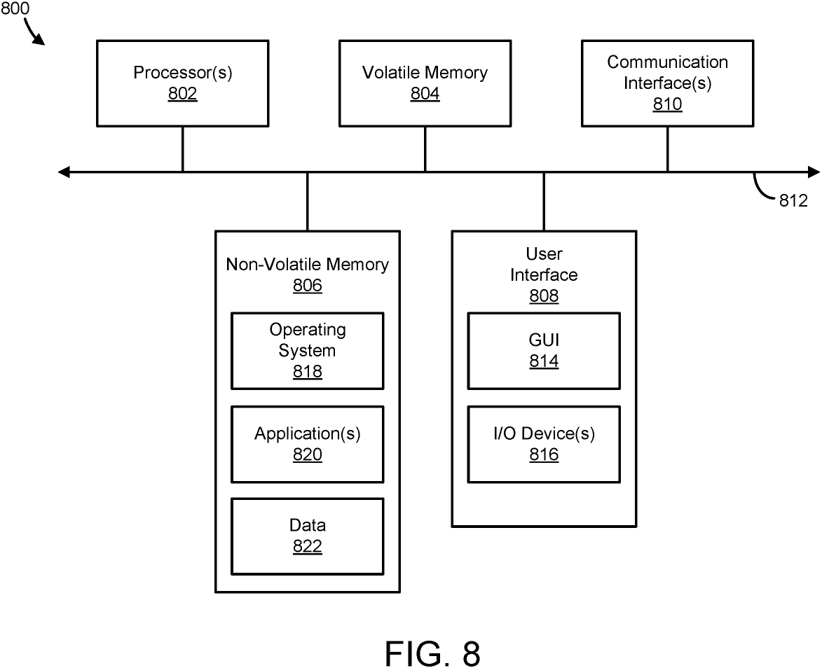

FIG. 8 depicts a block diagram of a computing device 800 useful for practicing an example of client devices 102 and 202, workspace servers 108 and 208, and/or IDP servers 108 and 208 as described above. The computing device 800 includes one or more processors 802, volatile memory 804 (e.g., random access memory (RAM)), non-volatile memory 806, user interface (UI) 808, one or more communications interfaces 810, and a communications bus 812. One or more of the computing devices 800 can also be referred to as a computer system.

The non-volatile memory 806 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 808 can include a graphical user interface (GUI) 814 (e.g., a touchscreen, a display, etc.) and one or more input/output (I/O) devices 816 (e.g., a mouse, a keyboard, a microphone, one or more speakers, one or more cameras, one or more biometric scanners, one or more environmental sensors, and one or more accelerometers, etc.).

The non-volatile memory 806 can store an operating system 818, one or more applications 820, and data 822 such that, for example, computer instructions of the operating system 818 and/or the applications 820 are executed by processor(s) 802 out of the volatile memory 804. In some examples, the volatile memory 804 can include one or more types of RAM and/or a cache memory that can offer a faster response time than a main memory. Data can be entered using an input device of the GUI 814 or received from the I/O device(s) 816. Various elements of the computing device 800 can communicate via the communications bus 812.

The illustrated computing device 800 is shown merely as an example client device or server and can be implemented by any computing or processing environment with any type of machine or set of machines that can have suitable hardware and/or software capable of operating as described herein.

The processor(s) 802 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 802 can be analog, digital or mixed. In some examples, the processor 802 can include multiple processor cores and/or multiple processors configured to provide functionality for parallel, simultaneous execution of instructions or for parallel, simultaneous execution of one instruction on more than one piece of data.

The communications interfaces 810 can include one or more interfaces to enable the computing device 800 to access a computer network such as a Local Area Network (LAN), a Wide Area Network (WAN), a Personal Area Network (PAN), or the Internet through a variety of wired and/or wireless connections, including cellular connections.

In described examples, the computing device 800 can execute an application on behalf of a user of a client device (e.g., client devices 102 and 202 as shown in FIGS. 1A, 1B, and 2A-2C and described above). For example, the computing device 800 can execute one or more virtual machines managed by a hypervisor and accessed via, for example, a client agent (e.g., client agent software 704 as shown in FIG. 7 and described above). Each virtual machine can provide an execution session within which applications execute on behalf of a user or a client device, such as a hosted desktop session. The computing device 800 can also execute a terminal services session to provide a distributed workspace environment. The computing device 800 can provide access to a remote computing environment including one or more applications, one or more desktop applications, and one or more desktop sessions in which one or more applications can execute.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

What is claimed is:

1. A method comprising:
receiving, by a processing device, authentication information based upon authentication of security credentials of a user of a distributed workspace;
launching, by the processing device, a distributed workspace session based upon the authentication information;
receiving, by the processing device, an input requesting access to an additional application;
blocking, by the processing device, an authentication process associated with the additional application;
executing, by the processing device, an alternative authentication process for the additional application using the authentication information for the user; and
providing, by the processing device, access to the additional application based upon successful completion of the alternative authentication process.

2. The method of claim 1, wherein the input requesting access to the additional application comprises a request to launch the application in a system browser distinct from the distributed workspace session.

3. The method of claim 2, wherein blocking an authentication process associated with the additional application comprises:
monitoring, by the processing device, communication information exchanged between the system browser and a remote computing device;
determining, by the processing device, whether the communication information comprises information related to launching the additional application; and
blocking, by the processing device, the authentication process associated with the additional application if the communication information comprises information related to the launching the additional application.

4. The method of claim 1, wherein the input requesting access to the additional application comprises a request to launch the application in a secure browser distinct from the distributed workspace session and operated in accordance with a secure browsing service.

5. The method of claim 4, wherein blocking an authentication process associated with the additional application comprises:
monitoring, by the processing device, communication information exchanged between the secure browser and a remote computing device;
determining, by the processing device, if the communication information comprises information related to launching the additional application; and
blocking, by the processing device, the authentication process associated with the additional application if the communication information comprises information related to the launching the additional application.

6. The method of claim 1, wherein launching the distributed workspace session based upon the authentication information comprises launching, by the processing device, the distributed workspace session as a WebView application.

7. The method of claim 1, further comprising performing, by the processing device, the authentication process associated with the additional application based upon an unsuccessful completion of the alternative authentication process.

8. A computing device comprising:
a computer readable memory;
at least one processor operably coupled to the memory and configured to:
receive authentication information based upon authentication of security credentials of a user of a distributed workspace,
launch a distributed workspace session based upon the authentication information,
receive an input requesting access to an additional application,
block an authentication process associated with the additional application,
execute an alternative authentication process for the additional application using the authentication information for the user, and
provide access to the additional application based upon successful completion of the alternative authentication process.

9. The computing device of claim 8, wherein the input requesting access to the additional application comprises a request to launch the application in a system browser distinct from the distributed workspace session.

10. The computing device of claim 9, wherein the at least one processor being configured to block an authentication process associated with the additional application comprises the at least one processor being configured to:
monitor communication information exchanged between the system browser and a remote computing device;
determining whether the communication information comprises information related to launching the additional application; and
block the authentication process associated with the additional application if the communication information comprises information related to the launching the additional application.

11. The computing device of claim 8, wherein the input requesting access to the additional application comprises a request to launch the application in a secure browser distinct from the distributed workspace session and operated in accordance with a secure browsing service.

12. The computing device of claim 11, wherein the at least one processor being configured to block an authentication process associated with the additional application comprises the at least one processor being configured to:
monitor communication information exchanged between the secure browser and a remote computing device;
determine if the communication information comprises information related to launching the additional application; and
block the authentication process associated with the additional application if the communication information comprises information related to the launching the additional application.

13. The computing device of claim 8, wherein the at least one processor being configured to launch the distributed workspace session based upon the authentication information comprises the at least one processor being configured to launch the distributed workspace session as a WebView application.

14. The computing device of claim 8, the at least one processor being further configured to perform the authentication process associated with the additional application based upon an unsuccessful completion of the alternative authentication process.

15. A system comprising:
a computer readable memory;
a network interface operably coupled to a remote computing device; and
at least one processor operably coupled to the memory and the network interface and configured to:
receive authentication information based upon authentication of security credentials of a user of a distributed workspace,
launch a distributed workspace session based upon the authentication information,
receive an input requesting access to an additional application,
block an authentication process associated with the additional application,
execute an alternative authentication process for the additional application, wherein to execute the alternate authentication process comprises the at least one processor being configured to
transmit an authentication request including the authentication information for the user to the remote computing device via the network interface, and
receive an authentication response from the remote computing device via the network interface, the authentication response comprising an indication of a successful completion of the alternative authentication process or an unsuccessful completion of the authentication process, and
provide access to the additional application based upon a successful completion of the alternative authentication process.

16. The system of claim 15, wherein the input requesting access to the additional application comprises a request to launch the application in a system browser distinct from the distributed workspace session.

17. The system of claim 16, wherein the at least one processor being configured to block an authentication process associated with the additional application comprises the at least one processor being configured to:
monitor communication information exchanged between the system browser and a remote computing device;
determining whether the communication information comprises information related to launching the additional application; and
block the authentication process associated with the additional application if the communication information comprises information related to the launching the additional application.

18. The system of claim 15, wherein the input requesting access to the additional application comprises a request to launch the application in a secure browser distinct from the distributed workspace session and operated in accordance with a secure browsing service.

19. The system of claim 18, wherein the at least one processor being configured to block an authentication process associated with the additional application comprises the at least one processor being configured to:
monitor communication information exchanged between the secure browser and a remote computing device;
determine if the communication information comprises information related to launching the additional application; and
block the authentication process associated with the additional application if the communication information comprises information related to the launching the additional application.

20. The system of claim 15, wherein the at least one processor being configured to launch the distributed workspace session based upon the authentication information comprises the at least one processor being configured to launch the distributed workspace session as a WebView application.
